(19) United States
(12) Patent Application Publication
(10) Pub. No.: US 2026/0290831 A1
(43) Pub. Date: Sep. 24, 2026

(54) POSITIVE ELECTRODE AND RECHARGEABLE LITHIUM BATTERY INCLUDING THE SAME

(71) Applicant: SAMSUNG SDI CO., LTD., Yongin-si (KR)

(72) Inventors: Seunghyun JEON, Yongin-si (KR); Youngkwang CHO, Yongin-si (KR); Moonju CHO, Yongin-si (KR); Seunghyun LIM, Yongin-si (KR); Yusun CHOI, Yongin-si (KR); Hyewon KIM, Yongin-si (KR)

(73) Assignee: SAMSUNG SDI CO., LTD., Yongin-si (KR)

(21) Appl. No.: 19/566,098

(22) Filed: Mar. 13, 2026

(30) Foreign Application Priority Data
Mar. 20, 2025 (KR) 10-2025-0036191

(51) Int. Cl. H01M 4/62; H01M 4/02; H01M 4/04; H01M 4/525; H01M 10/0525

(52) U.S. Cl. CPC H01M 4/622; H01M 4/0416; H01M 4/525; H01M 4/625; H01M 10/0525; H01M 2004/021; H01M 2004/028

(57) ABSTRACT

Disclosed are a positive electrode, and a rechargeable lithium battery including the positive electrode. The positive electrode includes a positive electrode current collector, a functional layer on at least one surface of the positive electrode current collector, and a positive electrode active material layer on the functional layer. The functional layer includes boron nitride and a binder, and the binder includes poly(meth)acrylic acid and a styrene-(meth)acrylate rubber.

### CROSS-REFERENCE TO RELATED APPLICATION

This application claims priority to Korean Patent Application No. 10-2025-0036191 filed with the Korean Intellectual Property Office on Mar. 20, 2025, the entire contents of which are incorporated herein by reference.

### BACKGROUND

### 1. Field

The present disclosure relates to a positive electrode, and a rechargeable lithium battery including the positive electrode.

### 2. Description of the Related Art

Rechargeable lithium batteries, which are easier to carry as well as exhibit high energy density, are widely used as power sources for mobile information terminals such as, e.g., smart phones, laptops, and the like. Research on rechargeable lithium batteries with high safety and high capacity is being conducted for the use as power sources for hybrid vehicles and electric vehicles, or for storing electric power.

Battery safety is relevant due to ignition challenges of rechargeable lithium batteries, and accordingly, various safety tests such as a nail penetration test in which the rechargeable lithium batteries are penetrated with a thin nail are conducted in the industry.

In this regard, a method for improving the safety of a rechargeable lithium battery by introducing a functional layer between the positive electrode current collector and the positive electrode active material layer is known. In the case of the functional layer, in order to improve or maximize the safety effect, the functional layer should be relatively thick, but the thicker the functional layer, the more negatively the energy density is affected. The binder used in conventional functional layers has limitations in that the binder has low oxidation stability under high-voltage conditions, which causes chemical deterioration and performance degradation. Accordingly, it may be advantageous to design a positive electrode that has favorable plate characteristics even under high-voltage conditions while ensuring high safety and high energy density.

### SUMMARY

Some example embodiments include a positive electrode for a rechargeable lithium battery that has desired or improved oxidation stability and advantageous electrochemical characteristics of the electrode plate while ensuring high safety and high energy density.

In some example embodiments, a positive electrode includes a positive electrode current collector, a functional layer on at least one surface of the positive electrode current collector, and a positive electrode active material layer on the functional layer. The functional layer includes boron nitride and a binder, and the binder includes poly(meth)acrylic acid and a styrene-(meth)acrylate rubber.

In some example embodiments, a rechargeable lithium battery includes the aforementioned positive electrode, negative electrode, and electrolyte.

According to some example embodiments, a positive electrode for a rechargeable lithium battery may secure high safety and high energy density while also having advantageous electrode plate characteristics (securing adhesive strength and viscosity).

### BRIEF DESCRIPTION OF THE DRAWINGS

FIG. 1 to FIG. 4 are cross-sectional views schematically showing rechargeable lithium batteries according to some example embodiments.

### DETAILED DESCRIPTION

Hereinafter, example embodiments are described in detail so that those of ordinary skill in the art can readily implement the example embodiments. However, this disclosure may be embodied in many different forms and is not construed as limited to the example embodiments set forth herein.

The terminology used herein is used to describe example embodiments, and is not intended to limit the present disclosure. The singular expression includes the plural expression unless the context clearly dictates otherwise.

As used herein, “combination thereof” means a mixture, a laminate, a composite, a copolymer, an alloy, a blend, a reaction product, and the like of the constituents.

Here, it should be understood that terms such as “comprises,” “includes,” or “have” are intended to designate the presence of an embodied feature, number, step, element, or a combination thereof, but it does not preclude the possibility of the presence or addition of one or more other features, number, step, element, or a combination thereof.

In the drawings, the thickness of layers, films, panels, regions, and the like, are exaggerated for clarity and like reference numerals designate like elements throughout the specification. It is understood that when an element such as a layer, film, region, or substrate is referred to as being “on” another element, the element can be directly on the other element, or intervening elements may also be present therebetween. In contrast, when an element is referred to as being “directly on” another element, there are no intervening elements present.

In addition, “layer” herein includes not only a shape formed on the whole surface when viewed from a plan view, but also a shape formed on a partial surface.

The average particle diameter may be measured by a method known to those skilled in the art, for example, by a particle size analyzer, or by a transmission electron microscope image or a scanning electron microscope image. Alternatively, it is possible to obtain an average particle diameter value by measuring the average particle diameter using a dynamic light scattering method, performing data analysis, counting the number of particles for each particle size range, and calculating the average particle diameter from this measurement. Unless otherwise defined, the average particle diameter may mean the diameter (D₅₀) of particles having a cumulative volume of 50 vol % in the particle size distribution. As used herein, when a definition is not otherwise provided, the average particle diameter means a diameter (D₅₀) of particles having a cumulative volume of 50 vol % in the particle size distribution that is obtained by measuring the size (diameter or major axis length) of about 20 particles at random in a scanning electron microscope image.

Herein, “or” is not to be construed as an exclusive meaning, for example, “A or B” is construed to include A, B, A+B, and the like.

“Metal” is interpreted as a concept including ordinary metals, transition metals and metalloids (semi-metals).

As used herein, poly(meth)acrylic acid means polyacrylic acid and polymethacrylic acid, and (meth)acrylate means acrylate and methacrylate.

Hereinafter, the positive electrode and rechargeable lithium battery are described sequentially.

When the terms “about” or “substantially” are used in this specification in connection with a numerical value, it is intended that the associated numerical value include a tolerance of ±10% around the stated numerical value. When ranges are specified, the range includes all values therebetween such as increments of 0.1%.

### Positive Electrode

The positive electrode according to some example embodiments includes a positive electrode current collector, a functional layer on at least one surface of the positive electrode current collector and a positive electrode active material layer on the functional layer, wherein the functional layer includes boron nitride and a binder, and the binder includes poly(meth)acrylic acid and a styrene-(meth)acrylate rubber.

The functional layer and the positive electrode active material layer may be disposed on one surface, or on both surfaces, of the positive electrode current collector. When the functional layer and the positive electrode active material layer are disposed on both surfaces of the positive electrode current collector, the capacity of the rechargeable lithium battery may be increased while ensuring safety.

### Functional Layer

The functional layer according to some example embodiments includes boron nitride and a binder. The components that constitutes the functional layer are described in detail below.

### Binder:

The binder includes poly(meth)acrylic acid and a styrene-(meth)acrylate rubber. Conventional functional layers include an organic binder. Examples of the organic binder include at least one of polyvinyl fluoride, polyvinyl pyrrolidone, polyurethane, polytetrafluoroethylene, polyvinylidene fluoride, polyethylene, polypropylene, and the like. When using such an organic binder, the thickness of the functional layer must be designed to be relatively thick to ensure safety, which makes it difficult to secure adhesive strength and viscosity, and to achieve high energy density. Accordingly, the inventors of the present disclosure use an aqueous binder in the functional layer instead of an organic binder. Among conventional aqueous binders, an aqueous binder including butadiene included to secure flexibility, such as styrene-butadiene rubber (SBR) binders, include a double bond structure, which is vulnerable to oxidation reactions and causes chemical deterioration and performance degradation at high voltages (e.g., 4.2 V or higher), and thus has low high-voltage oxidation safety, making it unsuitable for use as a binder of a functional layer.

Therefore, in some example embodiments, a combination of poly(meth)acrylic acid and styrene-(meth)acrylate rubber is used as a binder. When the binder is used, the phenomenon of uneven coating of the functional layer due to dissolution of the binder during formation of the functional layer may be reduced or prevented, and the phenomenon of uneven coating of the positive electrode active material layer coated on the functional layer may also be reduced or prevented. In addition, the safety of the battery may be secured by improving oxidation safety at high voltage. For example, when poly(meth)acrylic acid is used alone as a binder, the strong electrostatic characteristics of poly(meth)acrylic acid cause the active materials to become entangled with each other, resulting in shear thickening, rendering coating challenging. When the styrene-(meth)acrylate rubber is used alone as a binder, the dispersibility thereof within the slurry is deteriorated, rendering coating challenging. Meanwhile, if (when) the poly(meth)acrylic acid and styrene-(meth)acrylate rubber are used in combination, the electrostatic characteristics of poly(meth)acrylic acid may be reduced or suppressed and dispersibility may be improved, facilitating coating and improving oxidation stability at high voltage.

A functional layer according to some example embodiments may form a uniform coating layer compared to a functional layer including a conventional organic binder, and may secure oxidation stability at high voltage compared to a functional layer including an aqueous binder including butadiene.

A total amount of poly(meth)acrylic acid and styrene-(meth)acrylate based on 100 wt % of the functional layer may be in a range of about 5 wt % to about 30 wt %, about 5 wt % to about 25 wt %, or about 10 wt % to about 20 wt %. An amount of poly(meth)acrylic acid and styrene-(meth)acrylate rubber included in the functional layer may be appropriately adjusted to ensure appropriate adhesive strength and stability. A weight ratio (A/B) of an amount of poly(meth)acrylic acid (A) and an amount of styrene-(meth)acrylate rubber (B) in the functional layer may be in a range of about 0.5 to about 2. For example, the weight ratio (A/B) may be in a range of about 0.5 to about 2, about 0.5 to about 1.5, about 0.5 to about 1, or about 1 to about 2. By adjusting within the above range, the safety of the electrode may be secured while improving dispersibility, thereby enabling uniform coating.

### Boron Nitride:

The functional layer includes boron nitride. The boron nitride is a compound having endothermic properties, for example, hexagonal boron nitride (h-BN). The hexagonal boron nitride has high thermal conductivity and desired or improved electrical insulating characteristics. An average particle diameter (D₅₀) of the boron nitride is not particularly limited, but may be in a range of about 1 μm to about 10 μm, about 3 μm to about 8 μm, or about 4 μm to about 7 μm. Within the above range, the endothermic properties may be exhibited as desired. Based on the total amount of 100 wt % of the functional layer, the boron nitride may be included in an amount in a range of about 70 wt % to about 95 wt %, about 75 wt % to about 90 wt %, or about 80 wt % to about 90 wt %. Within the above range, the functional layer has endothermic properties and may improve the safety of the battery.

### Thickness of Functional Layer:

A thickness of the functional layer may be in a range of about 0.1 μm to about 5 μm, about 0.3 μm to about 3 μm, or about 0.5 μm to about 2 μm. Within the above range, the functional layer may ensure safety and not impair the capacity of the battery.

### Conductive Material:

The functional layer may further include a conductive material. Examples of the conductive material may include a carbon-based material such as at least one of natural graphite, artificial graphite, carbon black, acetylene black, Ketjen black, a carbon fiber, a carbon nanofiber, a carbon nanotube, and the like; a metal-based material of a metal powder or a metal fiber including at least one of copper, nickel, aluminum, silver, and the like; a conductive polymer such as a polyphenylene derivative; or a mixture thereof. For example, the conductive material may be added in the form of a conductive material pre-dispersed solution.

The conductive dispersion liquid may include a conductive material, a solvent, and a binder, wherein the binder may be or include poly(meth)acrylic acid, and the conductive material may be or include acetylene black. Additionally, the solvent may include at least one of a carbonate-based, ester-based, ether-based, ketone-based organic solvent or a combination thereof.

The conductive material pre-dispersed solution may have a solid content in a range of about 4 wt % to about 15 wt %, about 4 wt % to about 12 wt %, or about 5 wt % to about 10 wt %. For example, the conductive material may have a solid content in a range of about 2 wt % to about 10 wt %, about 2 wt % to about 6 wt %, or about 2 wt % to about 5 wt %, and the binder may be included in an amount in a range of about 1 wt % to about 5 wt %, about 1 wt % to about 4 wt %, or about 1.5 wt % to about 4 wt % in the conductive material pre-dispersed solution.

### Positive Electrode Active Material Layer

As described above, if (when) the functional layer is formed with a thin thickness, the positive electrode active material layer may be formed relatively thick. For example, a thickness ratio of the functional layer and the positive electrode active material layer may be in a range of about 1:5 to about 3:20. Within the above range, the safety of the positive electrode may be secured without deteriorating the capacity of the battery. Accordingly, the capacity of rechargeable lithium batteries may be improved.

The positive electrode active material may be or include a compound (lithiated intercalation compound) capable of intercalating and deintercalating lithium ions. For example, one or more types of composite oxides of lithium and a metal such as or including at least one of cobalt, manganese, nickel, and combinations thereof may be used.

The composite oxide may be or include a lithium transition metal composite oxide, and may include, for example, at least one of a lithium cobalt-based composite oxide, a lithium nickel-based composite oxide, a lithium nickel-cobalt-based composite oxide, a lithium nickel-cobalt-aluminum-based composite oxide, a lithium nickel-cobalt-manganese-based composite oxide, a lithium nickel-manganese-based oxide, a lithium manganese-based oxide, or a combination thereof.

As an example, a compound represented by any one of the following chemical formulas may be used. LiₐA_{1-b}X_{b}O_{2-c}D_{c} (0.90≤a≤1.8, 0≤b≤0.5, 0≤c≤0.05); LiₐMn_{2-b}X_{b}O_{4-c}D_{c} (0.90≤a≤1.8, 0≤b≤0.5, 0≤c≤0.05); LiₐNi_{1-b-c}Co_{b}X_{c}O_{2-α}D_{α} (0.90≤a≤1.8, 0≤b≤0.5, 0≤c≤0.5, 0<α<2); LiₐNi_{1-b-c}Mn_{b}X_{c}O_{2-α}D_{α} (0.90≤a≤1.8, 0≤b≤0.5, 0≤c≤0.5, 0<α<2); LiₐNi_{b}Co_{c}L¹_{d}GₑO₂ (0.90≤a≤1.8, 0≤b≤0.9, 0≤c≤0.5, 0≤d≤0.5, 0≤e≤0.1); LiₐNiG_{b}O₂ (0.90≤a≤1.8, 0.001≤b≤0.1); LiₐCoG_{b}O₂ (0.90≤a≤1.8, 0.001≤b≤0.1); LiₐMn_{1-b}G_{b}O₂ (0.90≤a≤1.8, 0.001≤b≤0.1); LiₐMn₂G_{b}O₄ (0.90≤a≤1.8, 0.001≤b≤0.1); LiₐMn_{1-g}G_{g}PO₄ (0.90≤a≤1.8, 0≤g≤0.5); Li_{(3-f)}Fe₂(PO₄)₃ (0≤f≤2); LiₐFePO₄ (0.90≤a≤1.8).

In the above chemical formulas, A is or includes at least one of Ni, Co, Mn, or a combination thereof; X is or includes at least one of Al, Ni, Co, Mn, Cr, Fe, Mg, Sr, V, a rare earth element, or a combination thereof; D is or includes at least one of O, F, S, P, or a combination thereof; G is or includes at least one of Al, Cr, Mn, Fe, Mg, La, Ce, Sr, V, or a combination thereof; and L¹ is or includes at least one of Mn, Al, or a combination thereof.

The positive electrode active material may include, for example, at least one of a lithium nickel-based oxide represented by Chemical Formula 11, a lithium cobalt-based oxide represented by Chemical Formula 12, a lithium iron phosphate-based compound represented by Chemical Formula 13, a cobalt-free lithium nickel-manganese-based oxide represented by Chemical Formula 14, or a combination thereof.

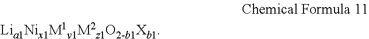

In Chemical Formula 11, 0.9≤a1≤1.8, 0.3≤x1≤1, 0≤y1≤0.7, 0≤z1≤0.7, 0.9≤x1+y1+z1≤1.1, and 0≤b1≤0.1, M¹ and M² each independently is or includes at least one of Al, B, Ba, Ca, Ce, Co, Cr, Cu, Fe, Mg, Mn, Mo, Nb, Si, Sn, Sr, Ti, V, W, Zr, or a combination thereof, and X is or includes at least one of F, P, S, or a combination thereof.

In Chemical Formula 11, 0.6≤x1≤1, 0≤y1≤0.4, and 0≤z1≤0.4; or 0.8≤x1≤1, 0≤y1≤0.2 and 0≤z1≤0.2.

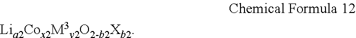

In Chemical Formula 12, 0.9≤a2≤1.8, 0.7≤x2≤1, 0≤y2≤0.3, 0.9≤x2+y2≤1.1, and 0≤b2≤0.1, M³ is or includes at least one of Al, B, Ba, Ca, Ce, Cr, Cu, Fe, Mg, Mn, Mo, Ni, Se, Si, Sn, Sr, Ti, V, W, Y, Zn, Zr, or a combination thereof, and X is or includes at least one of F, P, S, or a combination thereof.

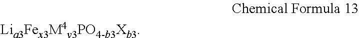

In Chemical Formula 13, 0.9≤a3≤1.8, 0.6≤x3≤1, 0≤y3≤0.4, and 0≤b3≤0.1, M⁴ is or includes at least one of Al, B, Ba, Ca, Ce, Cr, Cu, Fe, Mg, Mn, Mo, Ni, Se, Si, Sn, Sr, Ti, V, W, Y, Zn, Zr, or a combination thereof, and X is or includes at least one of F, P, S, or a combination thereof.

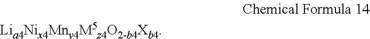

In Chemical Formula 14, 0.9≤a4≤1.8, 0.8≤x4<1, 0<y4≤0.2, 0≤z4≤0.2, 0.9≤x4+y4+z4≤1.1, and 0≤b4≤0.1, M⁵ is or includes at least one of Al, B, Ba, Ca, Ce, Cr, Cu, Fe, Mg, Mn, Mo, Ni, Se, Si, Sn, Sr, Ti, V, W, Y, Zn, Zr, or a combination thereof, and X is or includes at least one of F, P, S, or a combination thereof.

For example, the positive electrode active material may be or include a high-nickel positive electrode active material in which the nickel content is greater than or equal to about 80 mol %, greater than or equal to about 85 mol %, greater than or equal to about 90 mol %, greater than or equal to about 91 mol %, or greater than or equal to about 94 mol %, and less than or equal to about 99 mol %, based on 100 mol % of the metal excluding lithium in a lithium transition metal composite oxide. The high-nickel positive electrode active materials may achieve high capacity and may be applied to high-capacity, high-density rechargeable lithium batteries.

The positive electrode active material layer includes a positive electrode active material, and may further include a binder and/or a conductive material.

For example, the positive electrode may further include an additive that may constitute a sacrificial positive electrode.

An amount of the positive electrode active material may be in a range of about 90 wt % to about 99.5 wt % based on 100 wt % of the positive electrode active material layer, and amounts of the binder and conductive material may be in a range of 0.5 wt % to 5 wt %, respectively, based on 100 wt % of the positive electrode active material layer.

The binder improves binding properties of positive electrode active material particles with one another and with a current collector. Examples of the binder may include at least one of polyvinyl alcohol, carboxymethyl cellulose, hydroxypropyl cellulose, diacetyl cellulose, polyvinyl chloride, carboxylated polyvinyl chloride, polyvinyl fluoride, an ethylene oxide-containing polymer, polyvinylpyrrolidone, polyurethane, polytetrafluoroethylene, polyvinylidene fluoride, polyethylene, polypropylene, a styrene-butadiene rubber, a (meth)acrylated styrene-butadiene rubber, an epoxy resin, a (meth)acrylic resin, a polyester resin, and nylon, but are not limited thereto.

The conductive material is included to provide electrode conductivity, and any electrically conductive material may be used as a conductive material unless the electrically conductive material causes a chemical change. Examples of the conductive material may include a carbon-based material such as at least one of natural graphite, artificial graphite, carbon black, acetylene black, Ketjen black, a carbon fiber, a carbon nanofiber, a carbon nanotube, and the like; a metal-based material of a metal powder or a metal fiber including at least one of copper, nickel, aluminum, silver, and the like; a conductive polymer such as a polyphenylene derivative; or a mixture thereof.

### Method for Preparing Positive Electrode

In some example embodiments, a method for manufacturing a positive electrode includes providing a positive electrode current collector, preparing a functional layer composition including boron nitride and a binder, coating the functional layer composition on the positive electrode current collector to form a functional layer, preparing a positive electrode active material layer slurry including a positive electrode active material, and coating the positive electrode active material layer slurry on the functional layer to form a positive electrode active material layer. For example, the functional layer composition further includes a conductive material, and in the preparing of the functional layer composition, the conductive material may be added in the form of conductive material pre-dispersed solution. The conductive material pre-dispersed solution is as described above.

### Rechargeable Lithium Battery

Some example embodiments include a rechargeable lithium battery including the aforementioned positive electrode, negative electrode, and electrolyte. Because the rechargeable lithium battery includes the positive electrode of the aforementioned example embodiments, safety and capacity may be improved.

Hereinafter, a rechargeable lithium battery according to the above example embodiments is described in detail, excluding any description that overlaps with the aforementioned example embodiments.

### Negative Electrode Active Material

The negative electrode active material includes at least one of a material capable of reversibly intercalating/deintercalating lithium ions, lithium metal, an alloy of lithium metal, a material capable of doping and dedoping lithium, or a transition metal oxide.

The material capable of reversibly intercalating/deintercalating lithium ions may include, for example crystalline carbon, amorphous carbon, or a combination thereof as a carbon-based negative electrode active material. The crystalline carbon may be irregular, or sheet, flake, spherical, or fiber shaped natural graphite or artificial graphite. The amorphous carbon may be or include at least one of a soft carbon, a hard carbon, a mesophase pitch carbonization product, calcined coke, and the like.

As the lithium metal alloy, an alloy of lithium and a metal such as or including at least one of Na, K, Rb, Cs, Fr, Be, Mg, Ca, Sr, Si, Sb, Pb, In, Zn, Ba, Ra, Ge, Al, and Sn may be used.

The material capable of doping/dedoping lithium may be or include a Si-based negative electrode active material or a Sn-based negative electrode active material. The Si-based negative electrode active material may include at least one of silicon, a silicon-carbon composite, SiOₓ (0<x≤2), a Si-Q alloy (wherein Q is or includes at least one of an alkali metal, an alkaline-earth metal, a Group 13 element, a Group 14 element (excluding Si), a Group 15 element, a Group 16 element, a transition metal, a rare earth element, and a combination thereof), or a combination thereof. The Sn-based negative electrode active material may be or include at least one of Sn, SnO₂, a Sn-based alloy, or a combination thereof.

The silicon-carbon composite may be or include a composite of silicon and amorphous carbon. According to some example embodiments, the silicon-carbon composite may be in the form of silicon particles, and amorphous carbon coated on the surface of the silicon particles. For example, the silicon-carbon composite may include a secondary particle (core) in which silicon primary particles are assembled, and an amorphous carbon coating layer (shell) on the surface of the secondary particle. The amorphous carbon may also be present between the silicon primary particles, for example, the silicon primary particles may be coated with amorphous carbon. The secondary particles may be dispersed in an amorphous carbon matrix.

The silicon-carbon composite may further include crystalline carbon. For example, the silicon-carbon composite may include a core including crystalline carbon and silicon particles, and an amorphous carbon coating layer on the surface of the core.

The Si-based negative electrode active material or Sn-based negative electrode active material may be mixed with the carbon-based negative electrode active material.

### Negative Electrode

The negative electrode for a rechargeable lithium battery includes a current collector, and a negative electrode active material layer on the current collector. The negative electrode active material layer includes a negative electrode active material, and may further include a binder and/or a conductive material.

For example, the negative electrode active material layer may include a range of about 90 wt % to about 99 wt % of the negative electrode active material, a range of about 0.5 wt % to about 5 wt % of the binder, and a range of about 0 wt % to about 5 wt % of the conductive material.

The binder adheres the negative electrode active material particles to each other, and adheres the negative electrode active material to the current collector. The binder may be or include a non-aqueous binder, an aqueous binder, a dry binder, or a combination thereof.

The non-aqueous binder may include at least one of polyvinylchloride, carboxylated polyvinylchloride, polyvinylfluoride, an ethylene propylene copolymer, polystyrene, polyurethane, polytetrafluoroethylene, polyvinylidene fluoride, polyethylene, polypropylene, polyamideimide, polyimide, or a combination thereof.

The aqueous binder may include at least one of a styrene-butadiene rubber, a (meth)acrylated styrene-butadiene rubber, a (meth)acrylonitrile-butadiene rubber, a (meth)acrylic rubber, a butyl rubber, a fluorine rubber, polyethylene oxide, polyvinylpyrrolidone, polyepichlorohydrin, polyphosphazene, poly(meth)acrylonitrile, an ethylene propylene diene copolymer, polyvinylpyridine, chlorosulfonated polyethylene, latex, a polyester resin, a (meth)acrylic resin, a phenol resin, an epoxy resin, polyvinyl alcohol, or a combination thereof.

When an aqueous binder is used as the negative electrode binder, a cellulose-based compound capable of imparting viscosity may be further included. As the cellulose-based compound, at least one or more of carboxymethyl cellulose, hydroxypropylmethyl cellulose, methyl cellulose, or alkali metal salts thereof may be mixed and used. The alkali metal may be or include at least one of Na, K, or Li.

The dry binder may be or include a polymer material capable of becoming fiber, and may or include, for example, at least one of polytetrafluoroethylene, polyvinylidene fluoride, a polyvinylidene fluoride-hexafluoropropylene copolymer, polyethylene oxide, or a combination thereof.

The conductive material is included to provide electrode conductivity, and any electrically conductive material may be used as a conductive material unless the electrically conductive material causes a chemical change. Examples of the conductive material may include a carbon-based material such as at least one of natural graphite, artificial graphite, carbon black, acetylene black, Ketjen black, a carbon fiber, a carbon nanofiber, a carbon nanotube, and the like; a metal-based material of a metal powder or a metal fiber including at least one of copper, nickel, aluminum silver, and the like; a conductive polymer such as a polyphenylene derivative; or a mixture thereof.

The negative electrode current collector may include at least one of a copper foil, a nickel foil, a stainless steel foil, a titanium foil, a nickel foam, a copper foam, a polymer substrate coated with a conductive metal, and a combination thereof.

### Electrolyte

For example, the electrolyte for a rechargeable lithium battery may be or include an electrolyte solution, which may include a non-aqueous organic solvent and a lithium salt.

The non-aqueous organic solvent constitutes a medium for transmitting ions taking part in the electrochemical reaction of a battery.

The non-aqueous organic solvent may be or include at least one of a carbonate-based, ester-based, ether-based, ketone-based, or alcohol-based solvent, an aprotic solvent, or a combination thereof.

The carbonate-based solvent may include at least one of dimethyl carbonate (DMC), diethyl carbonate (DEC), dipropyl carbonate (DPC), methylpropyl carbonate (MPC), ethylpropyl carbonate (EPC), methylethyl carbonate (MEC), ethylene carbonate (EC), propylene carbonate (PC), butylene carbonate (BC), and the like. The ester-based solvent may include at least one of methyl acetate, ethyl acetate, n-propyl acetate, dimethyl acetate, methyl propionate, ethyl propionate, decanolide, ν-butyrolactone, mevalonolactone, valerolactone, caprolactone, and the like. The ether-based solvent may include at least one of dibutyl ether, tetraglyme, diglyme, dimethoxyethane, 2-methyltetrahydrofuran, 2,5-dimethyltetrahydrofuran, tetrahydrofuran, and the like. In addition, the ketone-based solvent may include cyclohexanone, and the like. The alcohol-based solvent may include ethanol, isopropyl alcohol, and the like. The aprotic solvent may include at least one of nitriles such as R—CN (wherein R is a C2 to C20 linear, branched, or cyclic hydrocarbon group, a double bond, an aromatic ring, or an ether group, and the like); amides such as dimethylformamide; dioxolanes such as 1,3-dioxolane, 1,4-dioxolane, and the like; sulfolanes, and the like.

The non-aqueous organic solvent may be used alone, or in a mixture of two or more types of solvents.

When using a carbonate-based solvent, a cyclic carbonate and a chain carbonate may be mixed together, and the cyclic carbonate and the chain carbonate may be mixed in a volume ratio in a range of about 1:1 to about 1:9.

The electrolyte may further include an additive of at least one of vinylethyl carbonate, vinylene carbonate, fluoroethylene carbonate, difluoro ethylenecarbonate, chloroethylene carbonate, dichloroethylene carbonate, bromoethylene carbonate, dibromoethylene carbonate, nitroethylene carbonate, cyanoethylene carbonate, or a combination thereof.

The lithium salt dissolved in the organic solvent supplies lithium ions in a battery, enables an operation of a rechargeable lithium battery, and improves transportation of the lithium ions between positive and negative electrodes. Examples of the lithium salt may include at least one of LiPF₆, LiBF₄, LiSbF₆, LiAsF₆, LiClO₄, LiAlO₂, LiAlCl₄, LIPO₂F₂, LiCl, LiI, LiN(SO₃C₂F₅)₂, Li(FSO₂)₂N (lithium bis(fluorosulfonyl)imide; LiFSI), LiC₄F₉SO₃, LiN(CₓF₂ₓ₊₁SO₂)(C_{y}F_{2y+1}SO₂) (wherein x and y are integers in a range of 1 to 20), lithium trifluoromethane sulfonate, lithium tetrafluoroethane sulfonate, lithium difluorobis(oxalato)phosphate (LiDFOB), and lithium bis(oxalato) borate (LiBOB).

### Separator

Depending on the type of the rechargeable lithium battery, a separator may be present between the positive electrode and the negative electrode. The separator may include at least one of polyethylene, polypropylene, polyvinylidene fluoride, or a multilayer film of two or more layers thereof, and a mixed multilayer film such as a polyethylene/polypropylene two-layer separator, polyethylene/polypropylene/polyethylene three-layer separator, polypropylene/polyethylene/polypropylene three-layer separator, and the like.

The separator may include a porous substrate and a coating layer including an organic material, an inorganic material, or a combination thereof on one surface, or on both surfaces, of the porous substrate.

The porous substrate may be or include a polymer film formed of or including any one polymer such as at least one of polyolefin such as polyethylene and polypropylene, polyester such as polyethylene terephthalate and polybutylene terephthalate, polyacetal, polyamide, polyimide, polycarbonate, polyether ketone, polyarylether ketone, polyether ketone, polyetherimide, polyamideimide, polybenzimidazole, polyethersulfone, polyphenylene oxide, a cyclic olefin copolymer, polyphenylene sulfide, polyethylene naphthalate, a glass fiber, TEFLON, and polytetrafluoroethylene, or a copolymer or mixture of two or more thereof.

The organic material may include a polyvinylidene fluoride-based polymer or a (meth)acrylic-based polymer.

The inorganic material may include inorganic particles such as or including at least one of Al₂O₃, SiO₂, TiO₂, SnO₂, CeO₂, MgO, NiO, CaO, GaO, ZnO, ZrO₂, Y₂O₃, SrTiO₃, BaTiO₃, Mg(OH)₂, boehmite, and a combination thereof, but is not limited thereto.

The organic material and the inorganic material may be mixed in one coating layer, or a coating layer including an organic material and a coating layer including an inorganic material may be stacked together.

### Rechargeable Lithium Battery

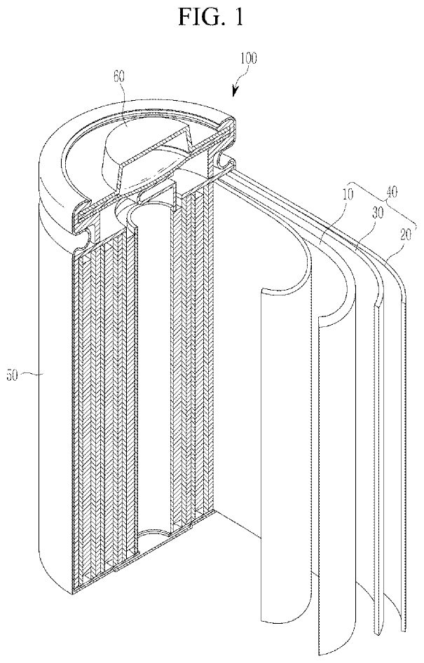

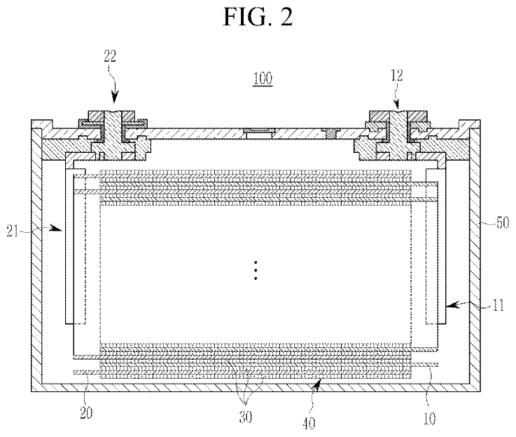

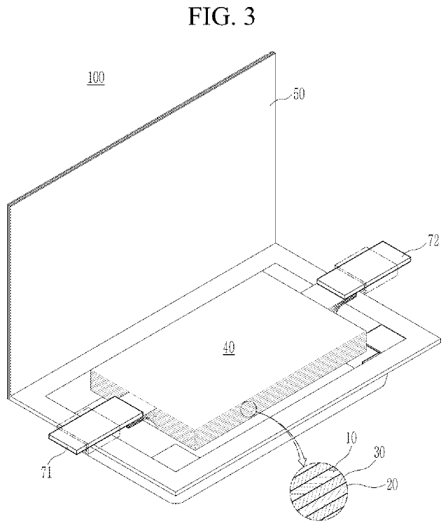

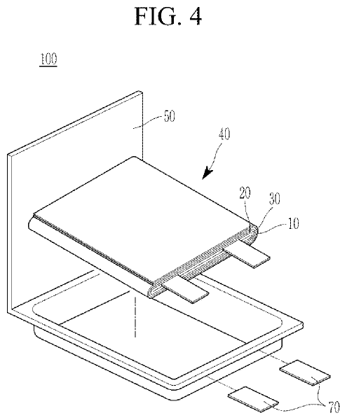

The rechargeable lithium battery may be classified into cylindrical, prismatic, pouch, coin, and the like, depending on the shape thereof. FIG. 1 to FIG. 4 are schematic diagrams showing the rechargeable lithium battery according to some example embodiments, where FIG. 1 is a cylindrical battery, FIG. 2 is a prismatic battery, and FIG. 3 and FIG. 4 are a pouch-shaped battery. Referring to FIG. 1 to FIG. 4, the rechargeable lithium battery 100 includes an electrode assembly 40 with a separator 30 interposed between the positive electrode 10 and the negative electrode 20, and a case 50 in which the electrode assembly 40 is housed. The positive electrode 10, the negative electrode 20, and the separator 30 may be impregnated with an electrolyte (not shown). The rechargeable lithium battery 100 may include a sealing member 60 that seals the case 50 as shown in FIG. 1. Additionally, in FIG. 2, the rechargeable lithium battery 100 may include a positive electrode lead tab 11, a positive electrode terminal 12 coupled to the positive electrode lead tab 11, a negative electrode lead tab 21, and a negative electrode terminal 22 coupled to the negative electrode lead tab 21. As shown in FIG. 3 and FIG. 4, the rechargeable lithium battery 100 includes an electrode tab 70 illustrated in FIG. 4, or a positive electrode tab 71 and a negative electrode tab 72 illustrated in FIG. 3, the electrode tabs 70/71/72 forming an electric path for inducing the current formed in the electrode assembly 40 to the outside of the battery 100.

The rechargeable lithium battery according to some example embodiments may be applicable to, e.g., automobiles, mobile phones, and/or various types of electrical devices, but the present disclosure is not limited thereto.

Hereinafter, examples of the present disclosure and comparative examples are described. These examples, however, are not in any sense to be interpreted as limiting the scope of the disclosure.

### Example 1

### (1) Manufacturing of Positive Electrode

A composition for a functional layer was prepared by dispersing polyacrylic acid as a binder and a styrene-acrylate rubber in distilled water, and then adding hexagonal boron nitride (D₅₀=6 μm) thereto. Herein, the polyacrylic acid, the styrene-acrylate rubber, and the boron nitride had a weight ratio of 5:5:90.

The composition for a functional layer was coated at a loading level of 0.8 mg/cm² on both surfaces of a 10 μm-thick Al foil as a positive electrode current collector, and then dried to form a functional layer on the positive electrode current collector.

On the other hand, LiCoO₂ as a positive electrode active material, polyvinylidene fluoride as a binder, and carbon nanotube as a conductive material were mixed in a weight ratio of 98.7:0.9:0.4 (=positive electrode active material:binder:conductive material) to prepare a positive electrode active material composition. This was dispersed in an N-methyl pyrrolidone solvent to prepare a positive electrode active material slurry, which was coated on the functional layer, and then dried and compressed to manufacture a positive electrode.

Herein, the functional layer had a total thickness of 4 μm on both surfaces, and the positive electrode active material layer had a total thickness of 70 μm on both surfaces.

### (2) Manufacturing of Negative Electrode

97.5 wt % of graphite as a negative electrode active material, 1.5 wt % of carboxymethyl cellulose as a binder, and 1 wt % of a styrene butadiene rubber were dispersed in distilled water to prepare a negative electrode active material slurry. This was coated on a 10 μm-thick Cu foil, and then dried and compressed to manufacture a negative electrode.

### (3) Manufacturing of Rechargeable Lithium Battery Cell

A 10 μm-thick polyethylene separator was interposed between the positive electrode and the negative electrode to manufacture an electrode assembly, which was inserted into a case, and an electrolyte was injected thereinto to manufacture a rechargeable lithium battery cell (a pouch cell of 100 mAh level). The electrolyte was prepared by dissolving 1.15 M LiPF₆ in a mixed solvent of EC (ethylenecarbonate):EMC (ethylmethylcarbonate):DMC (dimethylcarbonate) in a volume ratio of 2:4:4.

### Example 2

A positive electrode, a negative electrode, and a rechargeable lithium battery cell were manufactured substantially in the same manner as in Example 1, except that the weight ratio of polyacrylic acid, styrene-acrylate rubber, and boron nitride was changed to 10:5:85 to form a functional layer.

Herein, the functional layer had a total thickness of 4 μm on both surfaces, and the positive electrode active material layer had a total thickness of 70 μm on both surfaces.

### Example 3

A positive electrode, a negative electrode, and a rechargeable lithium battery cell were manufactured substantially in the same manner as in Example 1, except that the weight ratio of polyacrylic acid, styrene-acrylate rubber, and boron nitride was changed to 10:10:80 to form a functional layer.

Herein, the functional layer had a total thickness of 4 μm on both surfaces, and the positive electrode active material layer had a total thickness of 70 μm on both surfaces.

### Comparative Example 1

A positive electrode, a negative electrode, and a rechargeable lithium battery cell were manufactured substantially in the same manner as in Example 1 except that the weight ratio of styrene-acrylate rubber and boron nitride was changed to 10:90 to form a functional layer.

Herein, the functional layer had a total thickness of 4 μm on both surfaces, and the positive electrode active material layer had a total thickness of 70 μm on both surfaces.

### Comparative Example 2

A positive electrode, a negative electrode, and a rechargeable lithium battery cell were manufactured substantially in the same manner as in Example 1 except that the weight ratio of polyacrylic acid, styrene-acrylate rubber, and boron nitride was changed to 5:5:90 to form a functional layer.

Herein, the functional layer had a total thickness of 4 μm on both surfaces, and the positive electrode active material layer had a total thickness of 70 μm on both surfaces.

### Evaluation Example 1. Evaluation of Adhesive Strength of Functional Layer

The functional layers of the positive electrodes of Examples 1 to 3 and Comparative Examples 1 and 2 were measured with respect to adhesive strength. The adhesive strength between positive electrode current collector and functional layer was evaluated, and the results are shown in Table 1 below.

The adhesive strength test was performed in a method of attaching each of functional layers formed on an Al foil to a polyvinylchloride (PVC) double-sided adhesive tape, and peeling the functional layer at 25 mm/min to 180° therefrom, and the results are shown in Table 1 below.

TABLE 1

| | Adhesive strength (gf/mm) |
|---|---|
| Example 1 | 38.6 |
| Example 2 | 39.1 |
| Example 3 | 43.2 |
| Comparative Example 1 | 25.3 |
| Comparative Example 2 | 36.9 |

Referring to Table 1, in the positive electrodes of Examples 1 to 3, which included a functional layer including poly(meth)acrylic acid, a styrene-(meth)acrylate rubber, and boron nitride, exhibited adhesive strength of greater than or equal to 38 gf/mm, which was higher than the adhesive strength of the positive electrodes of Comparative Examples 1 and 2.

### Evaluation Example 2. Battery Performance Evaluation

The rechargeable lithium battery cells of Examples 1 to 3 and Comparative Examples 1 and 2 were constant current-charged to a voltage of 4.5 V at a current of 0.2 C and constant voltage-charged to a current of 0.02 C, while maintaining the 4.5 V, at 25° C. Subsequently, the cells were discharged to a voltage of 2.75 V at the constant current of 0.2 C.

Next, the cells were constant current-charged to a voltage of 4.16 V at a current of 1.3 C and constant voltage-charged to a current of 1.0 C, while maintaining the 4.16 V. Then, the cells were constant current-charged to a voltage of 4.28 V at the current of 1.0 C and constant voltage-charged to a current of 0.8 C, while maintaining the 4.28 V. Subsequently, the cells were constant current-charged to a voltage of 4.50 V at the current of 0.8 C and then, constant voltage-charged to a current of 0.1 C, while maintaining the 4.5 V. Then, the cells were discharged to a voltage of 3.2 V at the constant current of 0.5 C.

The above standard step was 50 cycles repeated to measure a room temperature cycle-life rate (%), and the results are shown in Table 2 below.

TABLE 2

| | Initial | Discharge | Cycle-life |
|---|---|---|---|
| | discharge | capacity | retention rate |
| | capacity | @50 cycle | @50 cycle |
| | (mAh) | (mAh) | (%) |
| Example 1 | 5145 | 5068 | 98.50 |
| Example 2 | 5097 | 5016 | 98.41 |
| Example 3 | 5168 | 4961 | 95.99 |
| Comparative Example 1 | 5101 | 4347 | 85.22 |
| Comparative Example 2 | 5105 | 3755 | 73.55 |

Referring to Table 2, the rechargeable lithium battery cells of Examples 1 to 3 were confirmed to exhibit a desired or improved cycle-life retention rate, compared to the rechargeable lithium battery cells of Comparative Examples 1 and 2.

The rechargeable lithium battery cells of Examples 1, 2, and 3 exhibited each initial discharge capacity of 5145 mAh, 5097 mAh, and 5168 mAh and each 50th discharge capacity of 5068 mAh, 5016 mAh, and 4961 mAh. When these results were used to calculate each cycle-life retention rate after the 50 cycles, the cycle-life retention rate of Example 1 was 98.50%, the cycle-life retention rate of Example 2 was 98.41%, and the cycle-life retention rate of Example 3 was 95.99%.

On the other hand, Comparative Example 1 exhibited a low cycle-life retention rate of 85.22%. This was understood to be due to insufficient dispersibility in the slurry, which reduced the adhesive strength, leading to an increase in interface resistance and a decrease in ionic conductivity, as structural collapse of the electrode progressed during the impregnation in the electrolyte solution.

In addition, Comparative Example 2 also exhibited a low cycle-life retention rate of 73.55%. The styrene-butadiene rubber included in the functional layer of Comparative Example 2 included a double bond capable of readily causing an oxidation reaction in a high voltage environment. In particular, as the oxidation progressed during the repetitive charge discharge processes, structural stability of the functional layer decreased, while sheet resistance increased, resulting in unsmooth ion transfer between electrode and electrolyte. If (when) this phenomenon persisted, the effect of protecting the functional layer might decrease, but the resistance on the electrode-electrolyte interface might further increase. As a result, it can be determined that as the cycles progressed, electrochemical performance of the electrode was deteriorated, and the cycle-life retention rate rapidly decreased along with the decrease in discharge capacity.

### Evaluation Example 3. Penetration Safety Evaluation

The rechargeable lithium battery cells of Examples 1 to 3 and Comparative Examples 1 and 2 were respectively prepared by groups of five, and then charged to an upper limit voltage of 4.5 V at a constant current of 0.5 C, cut off at a current of 0.05 C rate, while maintaining the constant voltage, and paused for 24 hours, and then penetrated at each speed of 100 mm/see and 150 mm/see by using a pin with a diameter of 3 mm to evaluate penetration stability according to the following criteria, and the results are shown in Table 3 below.

TABLE 3

| | Penetration speed (mm/s) | | | | | | | | | |
|---|---|---|---|---|---|---|---|---|---|---|
| | 100 mm/sec | | | | | 150 mm/sec | | | | |
| | 1 | 2 | 3 | 4 | 5 | 1 | 2 | 3 | 4 | 5 |
| Example 1 | ◯ | ◯ | X | ◯ | ◯ | ◯ | ◯ | ◯ | X | ◯ |
| Example 2 | ◯ | ◯ | ◯ | ◯ | X | ◯ | X | ◯ | ◯ | ◯ |
| Example 3 | ◯ | ◯ | ◯ | ◯ | ◯ | ◯ | ◯ | ◯ | ◯ | ◯ |

Evaluation Criteria:
X: Thermal runaway phenomenon observed at exposure temperature during penetration
◯: No thermal runaway phenomenon occurs at the exposure temperature during penetration.

Referring to Table 3, the rechargeable lithium battery cells of Examples 1 to 3 exhibited desired or improved penetration stability. For example, the rechargeable lithium battery cell of Example 3 exhibited no thermal runaway phenomenon at all the penetration speeds (100 mm/sec and 150 mm/sec) in the repeated experiments, which confirmed desired or improved stability. In addition, the rechargeable lithium battery cells of Examples 1 and 2 exhibited no thermal runaway phenomenon in most of the penetration experiments. Accordingly, the functional layer was confirmed to not only increase adhesive strength but also improve durability against external impact or mechanical deformation.

While this disclosure has been described in connection with what is presently considered to be practical example embodiments, it is to be understood that the disclosure is not limited to the disclosed example embodiments, but, on the contrary, is intended to cover various modifications and equivalent arrangements included within the spirit and scope of the appended claims.

Description of Symbols:

| | |
|---|---|
| 100: rechargeable lithium battery | 10: positive electrode |
| 11: positive electrode lead tab | 12: positive electrode terminal |
| 20: negative electrode | 21: negative electrode lead tab |
| 22: negative electrode terminal | 30: separator |
| 40: electrode assembly | 50: case |
| 60: sealing member | 70: electrode tab |
| 71: positive electrode tab | 72: negative electrode tab |

What is claimed is:

1. A positive electrode, comprising:
a positive electrode current collector;
a functional layer on the positive electrode current collector; and
a positive electrode active material layer on the functional layer,
wherein the functional layer comprises boron nitride and a binder, and
the binder comprises poly(meth)acrylic acid and a styrene-(meth)acrylate rubber.

2. The positive electrode as claimed in claim 1, wherein the boron nitride is included in an amount in a range of about 70 wt % to about 95 wt % based on a total amount of 100 wt % of the functional layer.

3. The positive electrode as claimed in claim 1, wherein the binder is included in an amount in a range of about 5 wt % to about 30 wt % based on a total amount of 100 wt % of the functional layer.

4. The positive electrode as claimed in claim 1, wherein a weight ratio (A/B) of an amount of poly(meth)acrylic acid (A) to an amount of styrene-(meth)acrylate rubber (B) in the functional layer is in a range of about 0.5 to about 2.

5. The positive electrode as claimed in claim 1, wherein the boron nitride comprises hexagonal boron nitride.

6. The positive electrode as claimed in claim 1, wherein the functional layer further comprises a conductive material.

7. The positive electrode as claimed in claim 1, wherein a thickness ratio of the functional layer and the positive electrode active material layer is in a range of about 1:5 to about 3:20.

8. The positive electrode as claimed in claim 1, wherein a thickness of the functional layer is in a range of about 0.5 μm to about 5 μm.

9. The positive electrode as claimed in claim 1, wherein:
the positive electrode active material layer comprises a positive electrode active material, and
the positive electrode active material comprises lithium transition metal composite oxide.

10. The positive electrode as claimed in claim 9, wherein the lithium transition metal composite oxide comprises at least one of a lithium cobalt-based composite oxide, a lithium nickel-based composite oxide, a lithium nickel-cobalt-based composite oxide, a lithium nickel-cobalt-aluminum-based composite oxide, a lithium nickel-cobalt-manganese-based composite oxide, a lithium nickel-manganese-based oxide, a lithium manganese-based oxide, and a combination thereof.

11. The positive electrode as claimed in claim 9, wherein the lithium transition metal composite oxide comprises a lithium nickel-based composite oxide represented by Chemical Formula 11, Chemical Formula 12, Chemical Formula 13, or Chemical Formula 14: 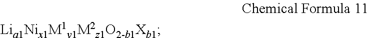
wherein, in Chemical Formula 11
0.9≤a1≤1.8, 0.3≤x1≤1, 0≤y1≤0.7, 0≤z1≤0.7, 0.9≤x1+y1+z1≤1.1, and 0≤b1≤0.1, 0.9≤a1≤1.8, 0.3≤x1≤1, 0≤y1≤0.7 and 0≤z≤0.1,
M¹ and M² are different from each other and each independently comprises at least one of Al, B, Ba, Ca, Ce, Co, Cr, Cu, Fe, Mg, Mn, Mo, Nb, Si, Sn, Sr, Ti, V, W, Y, Zn, Zr, and a combination thereof, and
X comprises at least one of F, P, S, and a combination thereof, 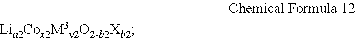
wherein, in Chemical Formula 12:
0.9≤a2≤1.8, 0.7≤x2≤1, 0≤y2≤0.3, 0.9≤x2+y2≤1.1, and 0≤b2≤0.1,
M³ comprises at least one of Al, B, Ba, Ca, Ce, Cr, Cu, Fe, Mg, Mn, Mo, Ni, Se, Si, Sn, Sr, Ti, V, W, Y, Zn, Zr, and a combination thereof, and
X comprises at least one of F, P, S, and a combination thereof, 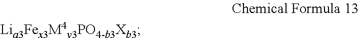
wherein, in Chemical Formula 13:
0.9≤a3≤1.8, 0.6≤x3≤1, 0≤y3≤0.4, and 0≤b3≤0.1,
M⁴ comprises at least one of Al, B, Ba, Ca, Ce, Cr, Cu, Fe, Mg, Mn, Mo, Ni, Se, Si, Sn, Sr, Ti, V, W, Y, Zn, Zr, and a combination thereof, and
X comprises at least one of F, P, S, and a combination thereof, 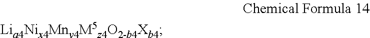
wherein, in Chemical Formula 14:
0.9≤a4≤1.8, 0.8≤x4<1, 0<y4≤0.2, 0≤z4≤0.2, 0.9≤x4+y4+z4≤1.1, and 0≤b4≤0.1,
M⁵ comprises at least one of Al, B, Ba, Ca, Ce, Cr, Cu, Fe, Mg, Mn, Mo, Ni, Se, Si, Sn, Sr, Ti, V, W, Y, Zn, Zr, and a combination thereof, and
X comprises at least one of F, P, S, and a combination thereof.

12. A method for manufacturing a positive electrode, the method comprising:
providing a positive electrode current collector;
preparing a functional layer composition including boron nitride and a binder;
coating the functional layer composition on the positive electrode current collector to form a functional layer;
preparing a positive electrode active material layer slurry including a positive electrode active material; and
coating the positive electrode active material layer slurry on the functional layer to form a positive electrode active material layer.

13. The method as claimed in claim 12, wherein:
the functional layer composition further comprises a conductive material, and
in the preparing of the functional layer composition, the conductive material is added in a form of conductive material pre-dispersed solution.

14. The method as claimed in claim 12, wherein:
the conductive material pre-dispersed solution comprises a conductive material, a solvent, and a binder, and
the binder comprises poly(meth)acrylic acid.

15. The method as claimed in claim 12, wherein the solvent comprises at least one of a carbonate-based, ester-based, ether-based, ketone-based organic solvent, and a combination thereof.

16. The method as claimed in claim 12, wherein a solid content of the conductive material pre-dispersed solution is in a range of about 4 wt % to about 15 wt %.

17. The method as claimed in claim 12, wherein the conductive material comprises at least one of natural graphite, artificial graphite, carbon black, acetylene black, Ketjen black, a carbon fiber, a carbon nanofiber, a carbon nanotube, and a combination thereof.

18. The method as claimed in claim 12, wherein a solid content of the conductive material is in a range of about 2 wt % to about 6 wt %.

19. A rechargeable lithium battery, comprising
the positive electrode as claimed in claim 1;
a negative electrode; and
an electrolyte.
